(19) United States
(12) Patent Application Publication
(10) Pub. No.: US 2013/0254127 A1
(43) Pub. Date: Sep. 26, 2013

(54) AUTHENTICATION METHOD AND AUTHENTICATION SYSTEM OF ELECTRONIC PRODUCT

(71) Applicant: ASUSTEK COMPUTER INC., Taipei (TW)

(72) Inventors: Hsin-Yi LEE, Taipei (TW); Chi-An LU, Taipei (TW); Meih-Suan WANG, Taipei (TW)

(73) Assignee: ASUSTEK COMPUTER INC., Taipei (TW)

(21) Appl. No.: 13/796,224

(22) Filed: Mar. 12, 2013

Related U.S. Application Data
(60) Provisional application No. 61/615,107, filed on Mar. 23, 2012.

(51) Int. Cl. G06Q 30/00

(52) U.S. Cl. CPC G06Q 30/018
USPC 705/317

(57) ABSTRACT

An authentication method and an authentication system of an electronic product are provided. The authentication method includes following steps: an electronic device is connected to a first authentication module via a network; the electronic device outputs first authentication information of the electronic product to the first authentication module; the first authentication module verifies the first authentication information and generates second authentication information corresponding to the electronic product; the first authentication module is connected to a second authentication module via the network; the first authentication module outputs the second authentication information to the second authentication module; and the second authentication module verifies the second authentication information. The present disclosure provides a multi-authentication method and an authentication system of the electronic product to activate corresponding services from service providers.

### CROSS-REFERENCE TO RELATED APPLICATION

This application claims the priority benefit of provisional application Ser. No. 61/615,107, filed on Mar. 23, 2012. The entirety of the above-mentioned patent application is hereby incorporated by reference herein and made a part of specification.

### BACKGROUND OF THE INVENTION

1. Field of the Invention

The invention relates to an authentication method and an authentication system of an electronic product and, more particularly, to a multi-verified authentication method and a multi-verified authentication system of an electronic product.

2. Description of the Related Art

Electronic products, such as a personal computer (PC) and a notebook, are necessary in daily life. However, as science technology develops, hardware, software and firmware of the electronic product and method improve greatly, and since users are not familiar with the electronic product, they usually cannot make full use of the electronic product.

Taking a PC as an example, since each user has different requirements, and different PCs are installed different operating systems with different languages or versions, the installation of the driving program is limited by versions. Common problems include reinstalling the driving program of a motherboard and updating the software or firmware of the computer. Most service providers provide an installing disk attached to a package of the PC or the notebook computer for the user to restore the operating system or install software.

However, if the user loses the installing disk, or the installed or updated software is a new version, the user should download and install the latest software via a website or a server of the service provider. If the user searches resources from the network, driving software and application programs of other providers may be installed to the motherboard by mistakes, which results in using errors of software resources and fake warranties, increases compatibility problems and reduces users loyalty to the original service providers.

On the other hand, when the problems about the electronic product occur, it is hard for the user to ask for indication and help from a person with relating knowledge or experience in short time.

### BRIEF SUMMARY OF THE INVENTION

An authentication method of an electronic product of the disclosure includes the following steps. An electronic device is connected to a first authentication module via network. First authentication information of the electronic product is outputted to the first authentication module by the electronic device. The first authentication information is verified and second authentication information is generated corresponding to the electronic product by the first authentication module. The second authentication information is outputted to a second authentication module by the first authentication module. The second authentication information is verified by the second authentication module.

An authentication system of an electronic product includes a first authentication module and a second authentication module. The first authentication module verifies first authentication information of the electronic product and generates second authentication information corresponding to the electronic product. The second authentication module is connected to the first authentication module and verifies the second authentication information from the first authentication module.

As stated above, the authentication method and the authentication system of the electronic product provides a safer service system for the users. They use two groups of authentication information corresponding to one electronic product to connect to the authentication system provided by the service provider, verify the version and compatibility of the hardware, the software and the firmware, and help the user to obtain required and correct driving programs or software from a remote terminal (such as a cloud server), so as to prevent piracy resources on the network damaging the electronic product. Moreover, the service provider can provide relating information and services to the user in authentication process via the authentication information and a database.

Additionally, a safer mutually beneficial environment is provided via a stored-value mutually beneficial method. The user can select another electronic product for assistance and build a mutual authentication after confirmation and selection according to corresponding grades of each electronic product at the stored-value mutually beneficial platform and preference, so as to get the safest assistance.

These and other features, aspects and advantages of the present invention will become better understood with regard to the following description, appended claims, and accompanying drawings.

### BRIEF DESCRIPTION OF THE DRAWINGS

FIG. 1A is a flow chart showing steps of an authentication method of an electronic product in an embodiment;

FIG. 1B is a block diagram showing an authentication system applying the authentication method of the electronic product in FIG. 1A;

FIG. 2A is a flow chart showing steps of a stored-value mutually beneficial method; and

FIG. 2B is a block diagram showing a stored-value mutually beneficial platform system applying the stored-value mutually beneficial method in FIG. 2A.

### DETAILED DESCRIPTION OF THE EMBODIMENTS

An authentication method and an authentication system of an electronic product, and a stored-value mutually beneficial method are illustrated with relating figures, and the same symbols denote the same components.

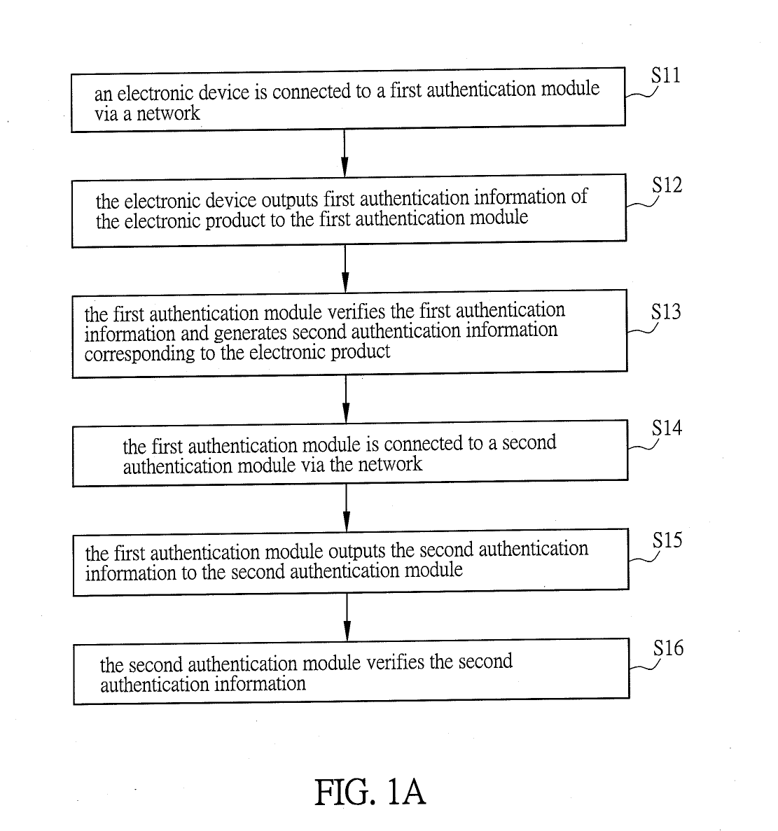

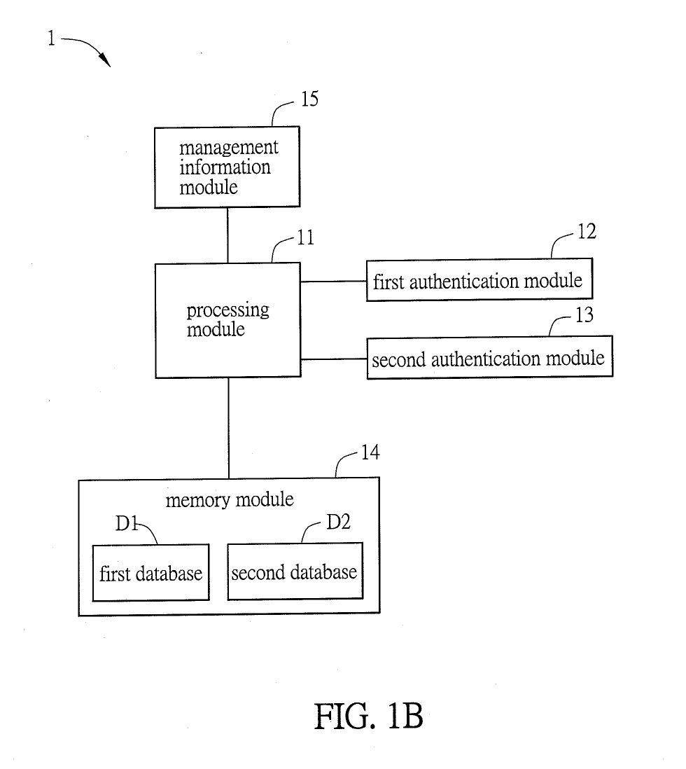

FIG. 1A is a flow chart showing steps of an authentication method of an electronic product in an embodiment. As shown in FIG. 1A, in the embodiment, the authentication method of the electronic product includes following steps. An electronic device is connected to a first authentication module via a network (S11). The electronic device outputs first authentication information of the electronic product to the first authentication module (S 12). The first authentication module verifies the first authentication information and generates second authentication information corresponding to the electronic product (S13). The first authentication module is connected to a second authentication module via the network (S 14). The first authentication module outputs the second authentication information to the second authentication module (S 15). The second authentication module verifies the second authentication information (S 16). Wherein the step (S 14) is not a necessary step, and it is just an example of this embodiment.

An electronic product (not shown) is taken as an example to illustrate the authentication method, which is not limited herein.

FIG. 1B is a block diagram showing an authentication system applying the authentication method of the electronic product in FIG. 1A. Please refer to FIG. 1A and FIG. 1B, the authentication system 1 applying the authentication method of the electronic product is provided by the service provider, and it includes a first authentication module 12 and a second authentication module 13. In the embodiment, the authentication system 1 is built in a remote website of the service provider, and the authentication system 1 may be an operating platform, which is not limited herein.

In step S11, the electronic device is connected to the authentication system 1 via the network.

In step S12, the electronic device outputs a first authentication information of the electronic product to the first authentication module. The electronic product includes a motherboard, a display or an input device, and the electronic product may be an electronic device, such as a computer or a mobile phone. In the embodiment, the electronic device is a computer as an example, the electronic product may be an electronic device which can be connected to the network, and the electronic product and the electronic device denote the same component, which is not limited herein. The user provides first authentication information to the authentication system 1 via an input device connected to the electronic product, such as a keyboard, a mouse, a track ball or a digital tablet. Furthermore, the first authentication information may be a product number or a universally unique identifier (UUID) of the electronic product. In the embodiment, the first authentication information is attached to the package of the electronic product. Taking a computer device as an example, the first authentication information may be embedded into the motherboard or a device body via a disk.

The user of the electronic product should register in a remote website W built by the service provider, so as to confirm that the user can download driving programs or software from the service provider at the remote website W.

In step S13, when the authentication system 1 receives the first authentication information from the electronic product, the authentication system 1 notices the first authentication module 12 to verify the first authentication information via the processing module 11. The processing module 11 extracts encrypted data corresponding to the first authentication information from a first database D1 of a memory module 14 of the authentication system 1, and verifies whether the first authentication information matches with the encrypted data via the first authentication module 12, which is not limited herein. The encrypted data corresponding to the first authentication information of the electronic product may be stored in other unites of the authentication system 1, such as the first authentication module, which is not limited herein.

In the embodiment, the encryption and decryption methods of the first authentication information by the authentication system 1 may include 3DES, advanced encryption standard (AES), RSA encryption algorithm, transport layer security (TLS), hash function or a combination of them all, which is not limited herein. The encryption method is known by persons having ordinary skill in the art, which is omitted herein.

When the first authentication information is verified by the first authentication module 12, the authentication system 1 compares the electronic product to the first database D1. In the embodiment, the first database D1 stores product information corresponding to the electronic product. “The product information” means the information provided by the service provider, such as an endorsement key included by a trusted platform module or a product number corresponding to the electronic product, for confirming the correctness of the electronic product. The “correctness of the electronic product” means the hardware, the software and the firmware of the electronic product with correct versions provided by the service provider.

As stated above, when the first authentication information is verified by the first authentication module 12, the first authentication module 12 provides an authentication packet of downloadable relating software information via the first database D1 simultaneously, and the authentication packet includes relating information of second authentication information. The second authentication information is inputted and verified in the subsequent authentication process.

After the authentication system 1 confirms if the version of the electronic product is correct, the electronic product executes the subsequent authentication via the authentication system 1. In step S14, the authentication system 1 instructs the processing module 11 to connect the first authentication module 12 and the second authentication module 13 via the network. In step S15, the first authentication module 12 outputs the second authentication information to the second authentication module 13. When the authentication system 1 receives the second authentication information from the first authentication module, the second authentication module 13 verifies the second authentication information in step S16. In step S16, the processing module 11 extracts the encrypted data corresponding to the electronic product from the memory module 14 of the authentication system 1, and verifies whether the second authentication information matches with the encrypted data via the second authentication module 13.

After the second authentication information is verified by the second authentication module 13 in step S16, the authentication system 1 verifies the compatibility and the version of the driving programs of the electronic product synchronously. After the verification is finished, the electronic product is connected to a management information module 15 for processing identity verification. Similarly, the identity verification is processed by the second authentication module 13 to confirm the user's identity and get services from the service provider.

Furthermore, when the second authentication module 13 confirms that the second authentication information is correct, the second authentication module 13 can verify and provide one or more downloadable data relating to the electronic product to the electronic device. In the embodiment, the second authentication module 13 should be connected to a second database D2 storing the downloadable data via the network to download and verify the data. The downloadable data may include application software compatible with the electronic product, and the downloadable data can be set by software developers, which is not limited herein.

As stated above, before the second authentication module 13 provides the downloadable data to the electronic device, the second authentication module verifies third authentication information of the downloadable data selected by the user or provided to ensure that the downloadable data are compatible with the electronic product. The third authentication information may also be used to confirm and check the version of the downloadable data, which is not limited herein.

In the embodiment, the third authentication information prevents the user of the electronic product from downloading fake software, and thus the third authentication information is included in the authentication packet. When the user downloads or installs software to the electronic product, the third authentication information can be mutually verified with an endorsement key or verification information included in the software, and thus the user can downloads safe and correct software.

Additionally, the second database D2 is a service unit which provides consultation or information about versions, which is not limited herein. The second database D2 may also be a custom service system, such as a service staff, to provide a feedback service for the user.

As stated above, after a mutual verification between the first authentication information, the second authentication information, the third authentication information and the authentication system 1 is finished at the electronic product, the authentication system 1 provides one or more software compatible with the electronic product to the electronic product. Comparing to the conventional service providers which provide services to the public without restrictions, the authentication method of the electronic product ensures that their own customs can obtain correct and unique services. On the other hand, when the operation system of the electronic product breaks down and needs to be reinstalled or restored, the user can obtain software in correct version (hardware configuration and software version) via remote mutual verification.

Furthermore, the steps of the verification of the first authentication information and the third authentication information can be executed repeatedly, which provides a verification system protection. On the other hand, after the electronic product finishes the verification with the authentication system, the downloaded and obtained software, the documents or driving programs are continuously transferred back to the electronic product via safe transmission. The method can provide a complete and safe verification process for the electronic product.

An authentication system of an electronic product is provided. The authentication system includes a first authentication module and a second authentication module, and the second authentication module is connected to the first authentication module. The first authentication module verifies first authentication information of the electronic product and generates second authentication information corresponding to the electronic product. The second authentication module verifies the second authentication information from the first authentication module. The authentication system is similar to the authentication system 1 in the embodiment above, and the steps of applying the system are stated, which is omitted herein. An inductive stored-value mutually beneficial method is further provided. When the second authentication module verifies the second authentication information is correct, the electronic device obtains a permission of a mutually beneficial platform, and the electronic device can get stored-value mutually beneficial services from other users or service providers via the mutually beneficial platform.

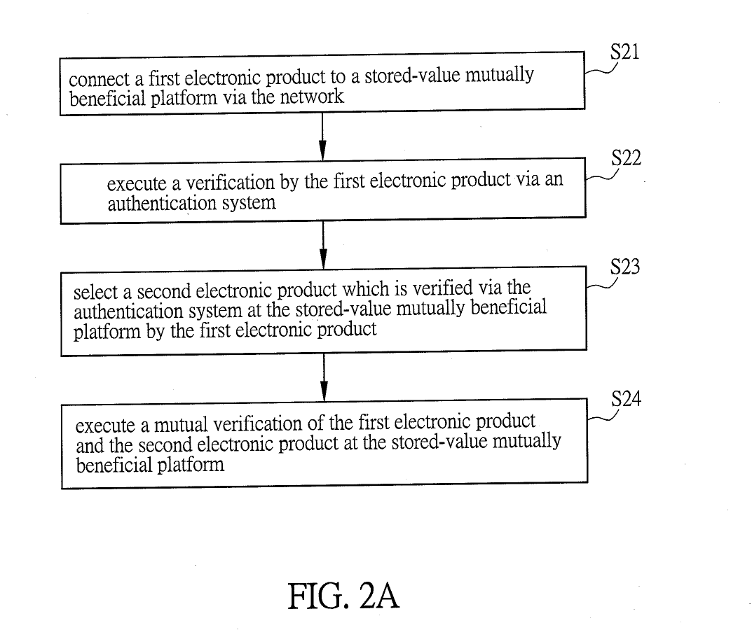

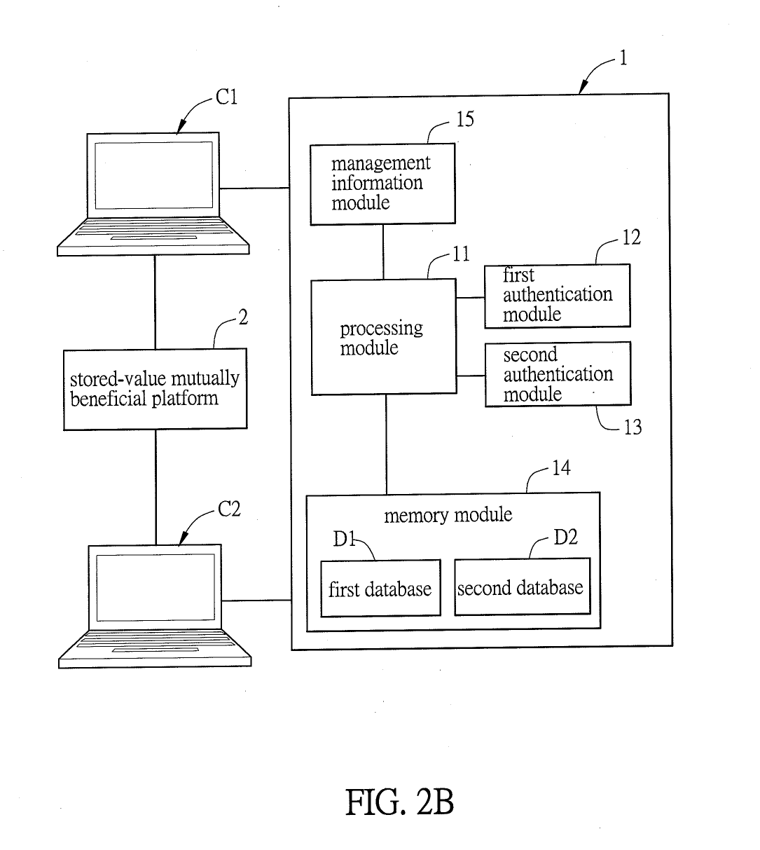

Please refer to FIG. 2A, the stored-value mutually beneficial method includes following steps: connecting a first electronic product to a stored-value mutually beneficial platform via the network (S21); executing a verification by the first electronic product via an authentication system (S22); selecting a second electronic product which is verified via the authentication system at the stored-value mutually beneficial platform by the first electronic product (S23); and executing a mutual verification of the first electronic product and the second electronic product at the stored-value mutually beneficial platform (S24). The verification method of the first electronic product, the second electronic product and the authentication system is similar to those in the embodiment above, which is omitted herein.

FIG. 2B is a block diagram showing a stored-value mutually beneficial platform system applying the stored-value mutually beneficial method in FIG. 2A. Please refer to FIG. 2A and FIG. 2B, in the embodiment, the remote website W built by the service provider further includes a stored-value mutually beneficial platform 2.

The stored-value mutually beneficial platform 2 is a social group or a discussion board built in the remote website W, and it is connected to the authentication system 1 via the network. When the user has a problem on the electronic product, he or she can connect the electronic product to the stored-value mutually beneficial platform 2 to search for another electronic product which is also verified via the authentication method illustrated above from the stored-value mutually beneficial platform 2, and the mutual verification is executed to solve the problems.

In the embodiment, the inductive stored-value mutually beneficial method is illustrated cooperating with two electronic products as an example. In step S21, the first electronic device C1 with authentication information of the first electronic product is connected to the inductive stored-value mutually beneficial platform 2 via the network. The inductive stored-value mutually beneficial platform 2 may be connected to multiple electronic products, which is not limited herein.

After the first electronic device C1 with the authentication information of the first electronic product is verified, the user can find any second electronic product at the stored-value mutually beneficial platform 2. The second electronic product is also verified in the authentication method, and it is connected to the inductive stored-value mutually beneficial platform.

In the embodiment, the first electronic device C 1 can be connected to a second electronic device C2 which includes the authentication information of the second electronic product via the stored-value mutually beneficial platform 2, and searches for appropriate software, driving devices or documents in the authentication method stated above.

As stated above, after the first electronic device C 1 including the authentication information of the first electronic product selects the second electronic device C2 including the authentication information of the second electronic product, the two electronic products execute a mutual verification and build a point-to-point authentication trust mechanism in step S24. The first electronic product may be the first electronic device C 1 and the second electronic product may be the second electronic device C2, which is not limited herein.

Furthermore, since the multiple electronic products connected to the inductive stored-value mutually beneficial platform 2 have different grades, the first electronic product can select an electronic product with more grades to execute a mutual verification and ask for assistance, which helps the first electronic product to get safe and correct assistance from the selected second electronic product. The “grades” means scores from the service provider or grades corresponding to purchase times, which is not limited herein.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An authentication method of an electronic product, comprising following steps:
an electronic device connected to a first authentication module via a network;
outputting first authentication information of the electronic product to the first authentication module by the electronic device;
verifying the first authentication information and generating second authentication information corresponding to the electronic product by the first authentication module;
outputting the second authentication information to a second authentication module by the first authentication module; and
verifying the second authentication information by the second authentication module.

2. The authentication method according to claim 1, wherein the electronic product includes the electronic device.

3. The authentication method according to claim 1, wherein the first authentication information is a product number or a universally unique identifier (UUID) of the electronic product.

4. The authentication method according to claim 1, wherein the authentication method further includes:
verifying and providing one or more downloadable data relating to the electronic product to the electronic device by the second authentication module when the second authentication module verifies the second authentication information is correct.

5. The authentication method according to claim 4, wherein the downloadable data includes application software.

6. The authentication method according to claim 4, wherein the authentication method further includes:
verifying third authentication information of the downloadable data by the second authentication module before the second authentication module provides the downloadable data relating to the electronic product to the electronic device.

7. The authentication method according to claim 4, wherein the authentication method further includes:
connecting the second authentication module to a second database which stores the downloadable data via the network before the second authentication module provides the downloadable data relating to the electronic product to the electronic device.

8. The authentication method according to claim 7, wherein the second database is a service unit.

9. The authentication method according to claim 1, wherein the authentication method further includes:
gaining a permission of a mutually beneficial platform via the electronic device when the second authentication module verifies the second authentication information is correct.

10. An authentication system of an electronic product, comprising:
a first authentication module verifying first authentication information of the electronic product and generating second authentication information corresponding to the electronic product; and
a second authentication module connected to the first authentication module and verifying the second authentication information from the first authentication module.
